(19) United States
(12) Patent Application Publication
(10) Pub. No.: US 2026/0262739 A1
(43) Pub. Date: Sep. 10, 2026

(54) POWER SUPPLY ASSEMBLY, ELECTRONIC ATOMIZATION DEVICE AND CONTROL METHOD THEREOF

(71) Applicant: SHENZHEN FIRST UNION TECHNOLOGY CO., LTD., Shenzhen, Guangdong (CN)

(72) Inventors: Xinjun LI, Shenzhen, Guangdong (CN); Zhongli XU, Shenzhen, Guangdong (CN); Yonghai LI, Shenzhen, Guangdong (CN)

(73) Assignee: SHENZHEN FIRST UNION TECHNOLOGY CO., LTD., Shenzhen, Guangdong (CN)

(21) Appl. No.: 18/873,297

(22) PCT Filed: Jun. 2, 2023
(86) PCT No.: PCT/CN2023/098066

§ 371 Date: Dec. 9, 2024

(30) Foreign Application Priority Data
Jun. 10, 2022 (CN) 202210657268.7

(51) Int. Cl. A24F 40/53; A24F 40/10; A24F 40/465; G01N 27/74

(52) U.S. Cl. CPC A24F 40/53; A24F 40/10; A24F 40/465; G01N 27/74

(57) ABSTRACT

A power supply assembly, an electronic atomization device, and a control method thereof are provided. The electronic atomization device includes: a liquid storage cavity for storing a liquid substrate; a power supply for providing electricity; a magnetic field generating circuit, electrically connected to the power supply and generating a varying magnetic field; a susceptor to be penetrated by the varying magnetic field to generate heat, to heat the liquid substrate to generate aerosols; and a controller, electrically connected to the magnetic field generating circuit and monitoring an electrical characteristic parameter of the magnetic field generating circuit and determining a type of the liquid substrate based on the electrical characteristic parameter of the magnetic field generating circuit. The type of the liquid substrate is determined according to the electrical characteristic parameter, and a power output curve suitable for the type of the liquid substrate can be provided.

### CROSS-REFERENCE TO RELATED APPLICATIONS

This application claims priority to Chinese Patent Application No. 202210657268.7, entitled “POWER SUPPLY ASSEMBLY, ELECTRONIC ATOMIZATION DEVICE, AND CONTROL METHOD THEREOF” and filed with the China National Intellectual Property Administration on Jun. 10, 2022, which is incorporated herein by reference in its entirety.

### TECHNICAL FIELD

This application relates to the field of electronic atomization technologies, and in particular, to a power supply assembly, an electronic atomization device, and a control method thereof.

### BACKGROUND

An electronic atomization device used as an example generally includes a liquid substrate, and the liquid substrate is atomized after being heated by a heating element, to generate inhalable aerosols. The liquid substrate may include nicotine and/or fragrance and/or aerosol-generating substances (for example, glycerol).

Different types of liquid substrates include different components, so that different liquid substrates have different atomization boiling points. If the electronic atomization device always performs an atomization operation on the liquid substrates at a same temperature during working, related components in a liquid substrate with a lower boiling point is easily damaged when high-temperature atomization is performed on the liquid substrate, resulting in a defect of a poor atomization effect of the liquid substrate.

In addition, some illegal vendors counterfeit cartridges (or atomizers) of regular vendors and sell the cartridges on the market, and quality of the cartridges cannot be ensured, which is likely to cause damage to the electronic atomization device. More seriously, liquid substrates that do not meet related standards in the cartridges and electronic components that cannot effectively atomize the cartridges may cause great harm to physical health.

### SUMMARY

According to an aspect of this application, an electronic atomization device is provided, including:
a liquid storage cavity, configured to store a liquid substrate; a power supply, configured to supply electricity;
a magnetic field generating circuit, electrically connected to the power supply and configured to generate a varying magnetic field;
a susceptor, configured to be penetrable by the varying magnetic field to generate heat, to heat the liquid substrate to generate aerosols; and
a controller, electrically connected to the magnetic field generating circuit, and configured to monitor an electrical characteristic parameter of the magnetic field generating circuit and determine a type of the liquid substrate based on the electrical characteristic parameter of the magnetic field generating circuit.

According to another aspect of this application, a power supply assembly is provided, configured to supply electricity to an atomizer of an electronic atomization device, where the atomizer includes a liquid storage cavity configured to store a liquid substrate and a susceptor configured to heat the liquid substrate to generate aerosols; and the power supply assembly includes:
a power supply, configured to supply electricity;
a magnetic field generating circuit, electrically connected to the power supply and configured to generate a varying magnetic field; and
a controller, electrically connected to the magnetic field generating circuit, and configured to monitor an electrical characteristic parameter of the magnetic field generating circuit and determine a type of the liquid substrate based on the electrical characteristic parameter of the magnetic field generating circuit.

According to another aspect of this application, a control method of an electronic atomization device is provided, where the electronic atomization device includes:
a liquid storage cavity, configured to store a liquid substrate;
a power supply, configured to supply electricity;
a magnetic field generating circuit, electrically connected to the power supply and configured to generate a varying magnetic field; and
a susceptor, configured to be penetrable by the varying magnetic field to generate heat, to heat the liquid substrate to generate aerosols; and
the method includes:
monitoring an electrical characteristic parameter of the magnetic field generating circuit, and determining a type of the liquid substrate based on the electrical characteristic parameter of the magnetic field generating circuit.

According to the foregoing electronic atomization device, the type of the liquid substrate is determined according to the electrical characteristic parameter of the magnetic field generating circuit, and a power output curve suitable for the type of the liquid substrate may be further provided, thereby improving the use experience of a user.

### BRIEF DESCRIPTION OF THE DRAWINGS

One or more embodiments are exemplarily described with reference to figures in the corresponding accompanying drawings, and the description does not constitute a limitation to the embodiments. Elements in the accompanying drawings that have same reference numerals are represented as similar elements, and unless otherwise particularly stated, the figures in the accompanying drawings are not drawn to scale.

FIG. 1 is a schematic diagram of an electronic atomization device according to an implementation of this application;

FIG. 2 is a block diagram of an electronic atomization device according to an implementation of this application;

FIG. 3 is a schematic diagram of a switch circuit and a resonance circuit according to an implementation of this application;

FIG. 4 is a schematic diagram of a detection circuit according to an implementation of this application; and

FIG. 5 is a schematic diagram of a relationship between inhalation time and a resonance voltage peak value according to an implementation of this application.

### DETAILED DESCRIPTION

For ease of understanding this application, this application is described below in more detail with reference to the accompanying drawings and specific implementations. It should be noted that, when an element is expressed as “being fixed to” another element, the element may be directly on the another element, or one or more intermediate elements may exist between the element and the another element. When an element is expressed as “being connected to” another element, the element may be directly connected to the another element, or one or more intermediate element may exist between the element and the another element. The terms “upper”, “lower”, “left”, “right”, “inner”, “outer”, and similar expressions used in this specification are merely used for an illustrative purpose.

Unless otherwise defined, meanings of all technical and scientific terms used in this specification are the same as those usually understood by a person skilled in the technical field to which this application belongs. In this specification, terms used in the specification of this application are merely intended to describe the specific implementations, but are not intended to limit this application. The term “and/or” used in this specification includes any and all combinations of one or more related listed items.

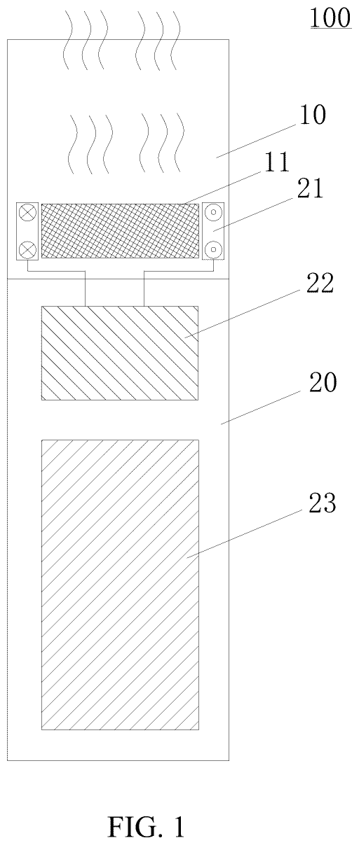

FIG. 1 is a schematic diagram of an electronic atomization device according to an implementation of this application.

As shown in FIG. 1, the electronic atomization device 100 includes an atomizer 10 and a power supply assembly 20. The atomizer 10 and the power supply assembly 20 are integrally formed.

The atomizer 10 includes a susceptor 11 and a liquid storage cavity (not shown). The liquid storage cavity is configured to store a liquid substrate that can be atomized; and the susceptor 11 is configured to be inductively coupled to an inductor 21 and to be penetrable by a varying magnetic field to generate heat, to heat the liquid substrate to generate inhalable aerosols.

Preferably, the liquid substrate includes a tobacco-contained material, and the tobacco-contained material includes volatile tobacco fragrance compounds released from the liquid substrate when being heated. Alternatively or in addition, the liquid substrate may include a non-tobacco material. The liquid substrate may include water, ethanol or another solvent, plant extracts, nicotine solution, and natural or artificial flavoring agents. Preferably, the liquid substrate further includes an aerosol forming agent. A suitable instance of the aerosol forming agent is glycerol and propylene.

Generally, the susceptor 11 may be made of at least one of the following materials: aluminum, iron, nickel, copper, bronze, cobalt, ordinary carbon steel, stainless steel, ferritic stainless steel, Martensitic stainless steel, or Austenitic stainless steel.

The power supply assembly 20 includes an inductor 21, a circuit 22, and a power supply 23.

The inductor 21 generates a varying magnetic field under an alternating current, and the inductor 21 includes but is not limited to an induction coil.

The power supply 23 provides electricity for operating the electronic atomization device 100. The power supply 23 may be a rechargeable battery core or a disposable battery core.

The circuit 22 may control overall operations of the electronic atomization device 100. The circuit 22 not only controls operations of the power supply 23 and the inductor 21, but also controls operations of other elements in the electronic atomization device 100.

It may be understood that, in addition to the components shown in FIG. 1, the electronic atomization device 100 may further include other components, for example, a liquid transferring element. The liquid transferring unit may be cotton fiber, metal fiber, ceramic fiber, glass fiber, porous ceramics, or the like. The liquid transferring unit may be in a shape of a rod, a tube, or a lever, or may be in a shape of a plate, a sheet, or a concave block with a concave cavity on a surface, or may be in a shape of an arch with an arched structure.

Different from the example in FIG. 1, in other examples, the atomizer 10 and the power supply assembly 20 may be formed separately. For example, the atomizer 10 and the power supply assembly 20 may be detachably connected to each other in a snap-in connection manner or a magnetic connection manner.

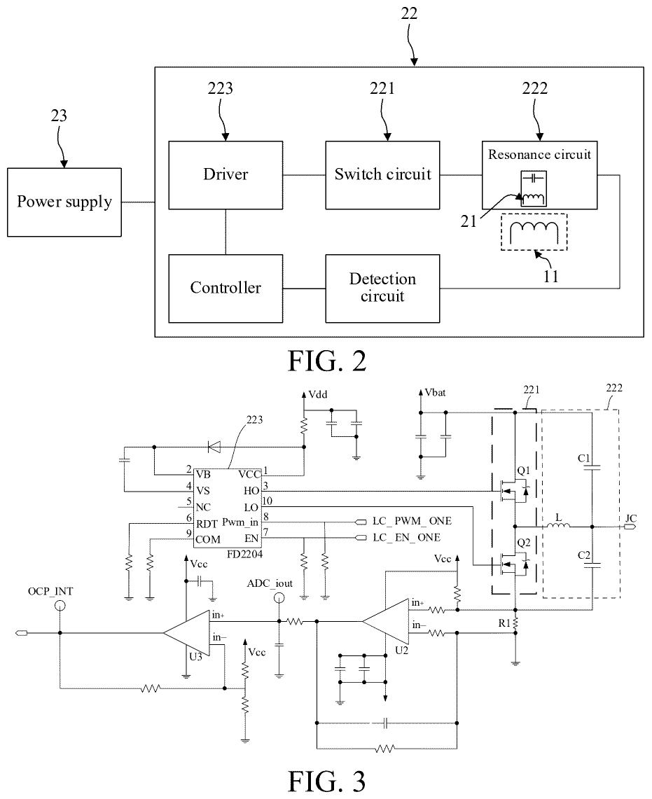

FIG. 2 and FIG. 3 show schematic diagrams of basic components of an embodiment of the circuit 22. The circuit 22 includes:
a magnetic field generating circuit, including a switch circuit 221 and a resonance circuit 222, where
the switch circuit 221 is a half-bridge circuit formed by transistor switches, and includes a switch tube Q1 and a switch tube Q2, which are configured to cause the resonance circuit 222 to resonate by switching turn-on and turn-off of the two switch tubes alternately; and
the resonance circuit 222 is formed by the inductor 21 (shown by L in the figure), a first capacitor C1, and a second capacitor C2, and the resonance circuit 222 is configured to form an alternating current flowing through the inductor L in a resonance process, to cause the inductor L to generate an alternating magnetic field, so as to induce the susceptor 11 to generate heat; and
a driver 223, configured to control the switch tube Q1 and the switch tube Q2 of the switch circuit 221 to be turned on and turned off alternately according to a control signal of a controller, where
the driver 223 is a switch tube driver of a commonly used FD2204 model, which is controlled by the controller in a PWM manner, and according to a pulse width of PWM, a third I/O interface and a tenth I/O interface alternately send a high level/a low level to drive turn-on time of the switch tube Q1 and the switch tube Q2, so as to control the resonance circuit 222 to resonate. In other examples, the driver 223 is integrated in the controller or implemented by the controller, which is also feasible.

In terms of connection, a first end of the first capacitor C1 is connected to Vbat (Vbat may be the power supply 23 or a power supply obtained after the power supply 23 is regulated), and a second end of the first capacitor is connected to a first end of the second capacitor C2; and a second end of the second capacitor C2 is grounded through a resistor R1.

A first end of the switch tube Q1 of the switch circuit 221 is connected to a positive electrode of Vbat, a second end of the switch tube Q1 is connected to a first end of the switch tube Q2, and a second end of the switch tube Q2 is grounded through the resistor R1. Certainly, control ends of the switch tube Q1 and the switch tube Q2 are both connected to the driver 223, and are turned on and turned off under driving of the driver 223. The switch tube Q1 and the switch tube Q2 include, but are not limited to IGBT transistors, MOS transistors, or the like.

A first end of the inductor L is connected to the second end of the switch tube Q1, and a second end of the inductor L is connected to the second end of the first capacitor C1. In addition, in terms of hardware selection of the resonance circuit 222, withstand voltages of the first capacitor C1 and the second capacitor C2 are far greater than an output voltage of the power supply 23. For example, in a common implementation, the output voltage of the used power supply 23 is approximately 4 V, and the withstand voltages of the used first capacitor C1 and second capacitor C2 range from 30 V to 80 V.

In a switching state of the switch tube Q1 and the switch tube Q2, in the resonance circuit 222 of the foregoing structure, connection states between the first capacitor C1 and the inductor L and between the second capacitor C2 and the inductor L are varying. When the switch tube Q1 is turned on and the switch tube Q2 is turned off, the first capacitor C1 and the inductor L jointly form a closed LC series circuit, and the second capacitor C2 and the inductor L form an LC series circuit with two ends respectively connected to Vbat and the ground (the circuit starts from Vbat, passes through the inductor L and the second capacitor C2 sequentially, and ends at a ground end). When the switch tube Q1 is turned off and the switch tube Q2 is turned on, formed circuits are opposite to the foregoing state, the first capacitor C1 and the inductor L form an LC series circuit with two ends respectively connected to Vbat and the ground, and the second capacitor C2 and the inductor L jointly form a closed LC series circuit. In different states, the first capacitor C1 and the second capacitor C2 can both form respective LC series circuits with the inductor L.

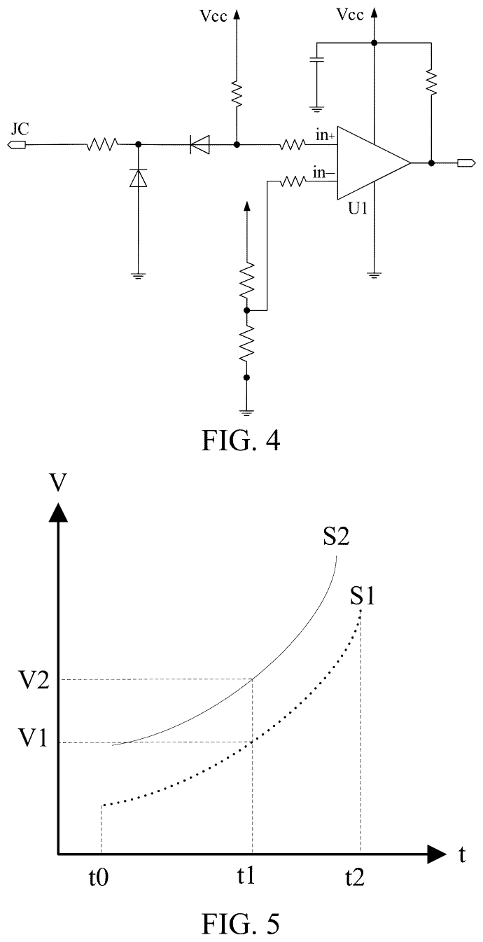

To accurately detect details such as a resonance process and a periodicity of the resonance circuit 222, as shown in FIG. 4, a detection circuit is further included during implementation and is configured to synchronously detect varying physical parameters such as a current, a voltage, or the periodicity in the resonance process of the resonance circuit 222. Specifically, in the embodiment shown in FIG. 4, the synchronous detection circuit includes an operational amplifier U1, and a signal input end detected by the detection circuit is connected to the second end of the inductor L (as shown by a JC connection end in the figure). In an optional implementation, a reference signal end of the operational amplifier U1 is directly set to 0, so that the operational amplifier U1 becomes a zero-crossing comparator configured to detect a moment at which a resonance current of the resonance circuit 222 is 0, and the controller obtains the varying physical parameters such as the current, the voltage, or the periodicity of the resonance circuit 222 according to a detection result in combination with a zero-crossing time point. It should be noted that, in some embodiments, the detection circuit is configured to sample a current value in the resonance circuit 222. A high-end current detection method may be used, for example, a sampling resistor is arranged between Vbat and the resonance circuit 222; or a low-end current detection method may be used, for example, a sampling resistor is arranged between the resonance circuit 222 and the ground end.

To obtain a specific susceptor, physical parameters such as a length, a thickness, a volume, and a weight of the susceptor 11 may be changed, or proportions of doping materials are changed, so that different susceptors 11 have different electrical conductivities and magnetic permeabilities. Magnetic coupling degrees between susceptors 11 with different volumes or weights and the same inductor 21 are different; or magnetic coupling degrees between susceptors 11 with different doping materials (with different magnetic permeabilities) and the same inductor 21 are also different. For example, for susceptors made of the same type of material, a susceptor 11 with a large size has a large magnetic coupling degree with the inductor 21, so that a resonance voltage value of the magnetic field generating circuit is small, and a current value of the magnetic field generating circuit is also small; and on the contrary, the resonance voltage value is large, and the current value is also large. When the magnetic permeability of the material of the susceptor 11 is large, the susceptor has a large magnetic coupling degree with the inductor 21, so that the resonance voltage value of the magnetic field generating circuit is small, and the current value is also small; and on the contrary, the susceptor has a small magnetic coupling degree with the inductor, the resonance voltage value is large, and the current value is also large. Based on the foregoing principles, tests are performed on different susceptors 11 in advance to record electrical characteristic parameters corresponding to the different susceptors 11, for example, the resonance voltage value or the current value of the magnetic field generating circuit, and the recorded values are pre-stored in a memory of the controller or an independent memory. Further, the different susceptors 11 are in a one-to-one correspondence with different liquid substrates. In this way, based on the electrical characteristic parameter of the magnetic field generating circuit, a type of a liquid substrate heated by the susceptor 11 may be determined.

FIG. 5 is used as an example, in FIG. 5, a horizontal coordinate represents inhalation time, and a vertical ordinate represents a resonance voltage peak value of the magnetic field generating circuit. S1 represents a relationship curve of inhalation time and resonance voltage peak values corresponding to a type of liquid substrate, and the data is pre-stored in the memory; S2 represents a relationship curve of inhalation time and resonance voltage peak values corresponding to a currently used liquid substrate, and the data is obtained through real-time monitoring; and working environments of the curve S1 and the curve S2 are the same, for example, working parameters such as the resonance frequencies are the same. a time period from t0 to t2 may be time that the electronic atomization device 100 is inhaled by one or more times. At a moment t1, the controller detects that a resonance voltage peak value corresponding to the currently used liquid substrate is V2, and it is learned by querying curve data pre-stored in the memory that a corresponding resonance voltage peak value is V1. By comparing V2 with V1, it may be determined that whether the currently used liquid substrate is the type of liquid substrate. In some examples, the controller is configured to calculate a deviation value between V2 and V1, and compares the deviation value with a preset deviation threshold, to determine whether the currently used liquid substrate is the type of liquid substrate according to a comparison result. Generally, when the deviation value is smaller than the deviation threshold, it may be determined that the currently used liquid substrate is an expected liquid substrate recorded in the memory. In an embodiment, the controller is configured to first determine a type of the susceptor 11 according to a resonance voltage of the magnetic field generating circuit, and then determine a type of the liquid substrate. Specifically, according to the resonance voltage value of the magnetic field generating circuit, pre-established correspondence data between electrical characteristic parameters and types of the susceptor is queried, and the type of the susceptor 11 is determined according to a queried result; and pre-established correspondence data between types of the susceptor and types of the liquid substrate is then queried, to determine the type of the liquid substrate.

In an embodiment, the controller is configured to directly query pre-established correspondence data between electrical characteristic parameters and types of the liquid substrate according to the resonance voltage of the magnetic field generating circuit, to determine the type of the liquid substrate.

If a corresponding result is found in the pre-established correspondence data between electrical characteristic parameters and types of the susceptor, it may be considered that an atomizer 10 including the susceptor 11 is a qualified atomizer 10, and the power supply 23 may be controlled to supply electricity to the atomizer. Otherwise, it may be considered that an atomizer 10 including the susceptor 11 is an unqualified atomizer 10 or a currently used atomizer 10 does not include a susceptor. In this case, the electricity supplied by the power supply 23 may be stopped.

After the type of the liquid substrate heated by the susceptor 11 is determined, the controller may perform an action in response to the determined type of the liquid substrate. In an example, the controller can control the electricity supplied by the power supply 23 to provide a power output curve suitable for the type of the liquid substrate, to improve the inhalation experience of a user. In an example, the controller can control to perform a related indication action, for example, display the determined type of the liquid substrate and main components of the liquid substrate, vendor information, seller information, and the like.

In an embodiment, the controller is configured to determine the power output curve suitable for the type of the liquid substrate according to pre-established correspondence data between electrical characteristic parameters and power output curves.

The pre-established correspondence data between electrical characteristic parameters and power output curves includes a plurality of different power output curves. Among different power output curves, one or more parameters such as power, voltages, currents, temperatures, or the like of the power output curves are different. One electrical characteristic parameter may correspond to one or more different power output curves, and a plurality of electrical characteristic parameters may correspond to one power output curve.

In a case that the type of the liquid substrate heated by the susceptor 11 cannot be determined, the electricity supplied by the power supply 23 may be stopped or a general temperature curve is provided.

In an embodiment, the controller is configured to determine the type of the liquid substrate according to a comparison result of the electrical characteristic parameter of the magnetic field generating circuit and a preset threshold or a preset threshold range. Specifically, the preset threshold or the preset threshold range may be obtained from the foregoing correspondence data or may be obtained in other ways. For example, the pre-established correspondence data between electrical characteristic parameters and types of the liquid substrate is (A, B). That is, if the electrical characteristic parameter is A, the type of the liquid substrate is B. In this case, the detected electrical characteristic parameter of the magnetic field generating circuit may be compared with A, and it may be determined that the type of the liquid substrate is B if the detected electrical characteristic parameter and A are the same; or it may be also determined that the type of the liquid substrate is B if a difference between the detected electrical characteristic parameter and A falls within a preset range; or it may be also determined that the type of the liquid substrate is B if a ratio of the detected electrical characteristic parameter to A falls within a preset range. In another example, the pre-established correspondence data between electrical characteristic parameters and types of the liquid substrate is (A1 to A2, B). That is, if the electrical characteristic parameter ranges from A1 to A2, the type of the liquid substrate is B. In this case, the detected electrical characteristic parameter of the magnetic field generating circuit may be compared with A1 and A2, to further determine the type of the liquid substrate.

It should be noted that, the foregoing examples are only described by using an LCC series resonance circuit as an example. In other examples, an LC series resonance circuit (including but not limited to half-bridge series resonance and full-bridge series resonance), an LC parallel resonance circuit, or the like may also be used for description.

It should be noted that, the foregoing examples are only described by using the resonance voltage of the magnetic field generating circuit as an example. It is conceivable that the electrical characteristic parameter of the magnetic field generating circuit includes at least one of the following: a current value, a quality factor Q, a resonance frequency, an inductance value, and another electrical characteristic parameter derived from the foregoing parameters. These electrical characteristic parameters may be obtained through direct (or passive) measurement or calculation.

It should be noted that, the specification of this application and the accompanying drawings thereof illustrate preferred embodiments of this application. However, this application can be implemented in various different forms, and is not limited to the embodiments described in this specification. These embodiments are not intended to be an additional limitation on the content of this application, and are described for the purpose of providing a more thorough and comprehensive understanding of the content disclosed in this application. Moreover, the above technical features can further be combined to form various embodiments not listed above, and all such embodiments shall be construed as falling within the scope recorded in the specification of this application. Further, a person of ordinary skill in the art may make improvements or variations according to the above description, and such improvements and variations shall all fall within the protection scope of the appended claims of this application.

1-12. (canceled)

13. An electronic atomization device comprising:
a liquid storage cavity configured to store a liquid substrate;
a power supply configured to supply electricity;
a magnetic field generating circuit, electrically connected to the power supply and configured to generate a varying magnetic field;
a susceptor configured to be penetrable by the varying magnetic field to generate heat, to heat the liquid substrate to generate aerosols; and
a controller, electrically connected to the magnetic field generating circuit, and configured to monitor an electrical characteristic parameter of the magnetic field generating circuit and determine a type of the liquid substrate based on the electrical characteristic parameter of the magnetic field generating circuit.

14. The electronic atomization device according to claim 13, wherein the electrical characteristic parameter of the magnetic field generating circuit comprises a current value.

15. The electronic atomization device according to claim 13, wherein the electrical characteristic parameter of the magnetic field generating circuit comprises a resonance voltage value.

16. The electronic atomization device according to claim 13, wherein the electrical characteristic parameter of the magnetic field generating circuit comprises a current value or a resonance voltage value.

17. The electronic atomization device according to claim 13, wherein the electrical characteristic parameter of the magnetic field generating circuit comprises at least one of the following:
a quality factor, a resonance frequency, an inductance value, or another electrical characteristic parameter derived from the foregoing parameters.

18. The electronic atomization device according to claim 13, wherein the controller is configured to determine the type of the liquid substrate according to the electrical characteristic parameter of the magnetic field generating circuit and a pre-established correspondence between electrical characteristic parameters and liquid substrate types.

19. The electronic atomization device according to claim 18, wherein the controller is configured to stop the electricity supplied by the power supply to the magnetic field generating circuit when the type of the liquid substrate is not determined according to the electrical characteristic parameter of the magnetic field generating circuit and the pre-established correspondence between electrical characteristic parameters and liquid substrate types.

20. The electronic atomization device according to claim 13, wherein the controller is configured to control, in response to a determined type of the liquid substrate, the electricity supplied by the power supply to the magnetic field generating circuit.

21. The electronic atomization device according to claim 20, wherein the controller is capable of controlling the electricity supplied by the power supply to the magnetic field generating circuit, to provide a power output curve suitable for the type of the liquid substrate.

22. The electronic atomization device according to claim 21, wherein the controller is configured to determine the power output curve suitable for the type of the liquid substrate according to the electrical characteristic parameter of the magnetic field generating circuit and a pre-established correspondence between electrical characteristic parameters and power output curves.

23. The electronic atomization device according to claim 13, wherein the controller is configured to determine the type of the liquid substrate according to a comparison result of the electrical characteristic parameter of the magnetic field generating circuit and a preset threshold or a preset threshold range.

24. The electronic atomization device according to claim 13, wherein:
the magnetic field generating circuit comprises a switch circuit and a resonance circuit, wherein the resonance circuit comprises an inductor and a capacitor; and
the switch circuit is configured to be turned on and turned off alternately under driving of a pulse signal, to cause an alternating current to flow through the inductor in the resonance circuit and generate the varying magnetic field.

25. The electronic atomization device according to claim 13, wherein:
the electronic atomization device comprises a power supply assembly and an atomizer removably connected to the power supply assembly; and
the power supply, the magnetic field generating circuit, and the controller are all arranged in the power supply assembly; and the susceptor is arranged in the atomizer and the atomizer comprises the liquid substrate.

26. A power supply assembly configured to supply electricity to an atomizer of an electronic atomization device, wherein the atomizer comprises a liquid storage cavity configured to store a liquid substrate and a susceptor configured to heat the liquid substrate to generate aerosols; the power supply assembly comprising:
a power supply configured to supply electricity;
a magnetic field generating circuit, electrically connected to the power supply and configured to generate a varying magnetic field; and
a controller, electrically connected to the magnetic field generating circuit, and configured to monitor an electrical characteristic parameter of the magnetic field generating circuit and determine a type of the liquid substrate based on the electrical characteristic parameter of the magnetic field generating circuit.

27. A control method of an electronic atomization device,
the electronic atomization device comprises:
a liquid storage cavity configured to store a liquid substrate;
a power supply configured to supply electricity;
a magnetic field generating circuit, electrically connected to the power supply and configured to generate a varying magnetic field; and
a susceptor configured to be penetrable by the varying magnetic field to generate heat, to heat the liquid substrate to generate aerosols;
the method comprising:
monitoring an electrical characteristic parameter of the magnetic field generating circuit; and
determining a type of the liquid substrate based on the electrical characteristic parameter of the magnetic field generating circuit.
